(19) United States
(12) Patent Application Publication
(10) Pub. No.: US 2025/0111968 A1
(43) Pub. Date: Apr. 3, 2025

(54) SOFT MAGNETIC METAL POWDER, MAGNETIC CORE, AND MAGNETIC COMPONENT

(71) Applicant: TDK Corporation, Tokyo (JP)

(72) Inventors: Kazuhiro YOSHIDOME, Tokyo (JP); Hiroyuki Matsumoto, Tokyo (JP); Shota Otsuka, Tokyo (JP); Masashi Ito, Tokyo (JP); Hitoshi Ohkubo, Tokyo (JP)

(73) Assignee: TDK Corporation, Tokyo (JP)

(21) Appl. No.: 18/899,295

(22) Filed: Sep. 27, 2024

(30) Foreign Application Priority Data
Sep. 28, 2023 (JP) 2023-168535

(51) Int. Cl. H01F 3/08; H01F 1/20; H01F 41/02

(52) U.S. Cl. CPC H01F 3/08; H01F 1/20; H01F 41/0246

(57) ABSTRACT

A soft magnetic metal powder includes soft magnetic metal particles with a particle size of 5.0 μm or more. (y₉₅/y₅₀−y₉₀/y₅₀)/(0.95−0.90) is 20.0 or less, where y₉₅ (μm) denotes D95, y₉₀ (μm) denotes D90, and y₅₀ (μm) denotes D50 of a particle size distribution of the soft magnetic metal particles with a particle size of 5.0 μm or more. A magnetic core includes soft magnetic metal particles with a Heywood diameter of 5.0 μm or more in a section of the magnetic core. (Y₉₅/Y₅₀−Y₉₀/Y₅₀)/(0.95−0.90) is 20.0 or less, where Y₉₅ (μm) denotes D95, Y₉₀ (μm) denotes D90, and Y₅₀ (μm) denotes D50 of a particle size distribution of the soft magnetic metal particles with a Heywood diameter of 5.0 μm or more.

### TECHNICAL FIELD

The present invention relates to a soft magnetic metal powder, a magnetic core, and a magnetic component.

### BACKGROUND

Patent Document 1 discloses an inductor in which a coil portion and a dust core manufactured by pressing a metal magnetic powder are integrally molded.

In a situation where a metal magnetic powder is used for a dust core, its core losses are readily increased. Using an amorphous alloy powder as the metal magnetic powder reduces core losses; however, it becomes difficult to increase the density of the dust core at the time of molding.

Patent Document 2 and Patent Document 3 disclose use of a mixture of a crystalline alloy magnetic powder and an amorphous alloy magnetic powder.

Patent Document 4 discloses that use of an amorphous soft magnetic powder having a high average working sphericity can provide an inductor or the like with less losses than a conventional inductor or the like.
Patent Document 1: JP Patent Application Laid Open No. 2003-309024
Patent Document 2: JP Patent Application Laid Open No. 2004-197218
Patent Document 3: JP Patent Application Laid Open No. 2004-363466
Patent Document 4: JP Patent No. 5110660

### SUMMARY

It is an object of an exemplary embodiment of the present invention to provide a soft magnetic metal powder with which a magnetic core having improved DC superimposition characteristics can be manufactured and a magnetic core or the like having improved DC superimposition characteristics.

To achieve the above object, a soft magnetic metal powder of an exemplary embodiment of the present invention is
a soft magnetic metal powder including soft magnetic metal particles with a particle size of 5.0 μm or more, wherein (y₉₅/y₅₀−y₉₀/y₅₀)/(0.95−0.90) is 20.0 or less, where y₉₅ (μm) denotes D95, y₉₀ (μm) denotes D90, and y₅₀ (μm) denotes D50 of a particle size distribution of the soft magnetic metal particles with a particle size of 5.0 μm or more.

D50 of a particle size distribution of all soft magnetic metal particles included in the soft magnetic metal powder may be 3.0 μm or more and 30.0 μm or less.

To achieve the above object, a magnetic core of an exemplary embodiment according to
a first aspect of the present invention is
a magnetic core including the above soft magnetic metal powder.

To achieve the above object, a magnetic core of an exemplary embodiment according to
a second aspect of the present invention is
a magnetic core including soft magnetic metal particles with a Heywood diameter of 5.0 μm or more in a section of the magnetic core, wherein (Y₉₅/Y₅₀−Y₉₀/Y 50)/(0.95−0.90) is 20.0 or less, where Y₉₅ (μm) denotes D95, Y₉₀ (μm) denotes D90, and Y₅₀ (μm) denotes D50 of a particle size distribution of the soft magnetic metal particles with a Heywood diameter of 5.0 μm or more.

A magnetic material may account for an area ratio of 70% or more and 95% or less of a section of the magnetic core.

A magnetic component of an exemplary embodiment of the present invention includes the above magnetic core.

### BRIEF DESCRIPTION OF THE DRAWING(S)

FIG. 1 is an example chart generated in an X-ray crystal structure analysis.

FIG. 2 is a plurality of example patterns obtained by profile fitting of the chart of FIG. 1.

### DETAILED DESCRIPTION

Hereinafter, a soft magnetic metal powder and a magnetic core according to an embodiment of the present invention are described. Before their description is provided, a method of measuring particle sizes of soft magnetic metal particles included in the soft magnetic metal powder and a method of measuring particle sizes of soft magnetic metal particles included in the magnetic core are described. The particle sizes of the particles denote their projected area diameters. The projected area diameters may simply be referred to as equivalent circle diameters.

Any method of measuring the particle sizes of the soft magnetic metal particles included in the soft magnetic metal powder may be used. Various particle size analyses (e.g., a laser diffraction method) can be used for measurement. In particular, a particle characterization system Morphologi G3 (Malvern Panalytical) may be used. Morphologi G3 is a system that enables a powder to be dispersed using air to project individual particle shapes for evaluation.

Specifically, from the projected areas of the individual particles, the equivalent circle diameters (particle sizes) of the individual particles can be obtained. In the present embodiment, the equivalent circle diameters of at least 2,000 particles or preferably at least 20,000 particles are measured.

Because Morphologi G3 can generate projections of multiple particles at one time for evaluation, shapes of the multiple particles can be evaluated in a short amount of time. Thus, Morphologi G3 is suitable for evaluating the particle size distribution and the like of the soft magnetic metal powder prior to molding. The projections of the multiple particles can be generated for automatic calculation of their individual particle sizes.

Next, a method of measuring the particle sizes of the soft magnetic metal particles included in the magnetic core according to the present embodiment is described. First, any part of the magnetic core is cut off to obtain a section of the magnetic core. The section is then observed. Any method of observing the section may be used. For example, an electron microscope (e.g., a SEM, a STEM, or a TEM) may be used. The field of view and magnification are not limited as long as individual sectional shapes of at least 2,000 soft magnetic metal particles can be observed.

Then, the equivalent circle diameters (Heywood diameters) of the individual particles included in the field of view are calculated. Any method of calculating the equivalent circle diameters may be used. For example, an analysis program may be used. However, in a situation where the analysis program or the like is used, portions that are apparently not particles may be recognized as particles. Such portions are appropriately left out in the calculation.

A number-based particle size distribution of the soft magnetic metal powder confirmed with Morphologi G3 and a number-based particle size distribution of the soft magnetic metal particles in a section of the magnetic core eventually obtained do not correspond.

However, the number-based particle size distribution of the soft magnetic metal powder confirmed with Morphologi G3 and the number-based particle size distribution of the soft magnetic metal particles in a section of the magnetic core eventually obtained are correlated. Thus, confirmation of the particle size distribution of the soft magnetic metal powder with Morphologi G3 enables, to some degree, estimation of the particle size distribution of the soft magnetic metal particles in a section of the magnetic core eventually obtained. That is, the number-based particle size distribution of the soft magnetic metal particles in a section of the magnetic core eventually obtained is easily controlled by control of the number-based particle size distribution of the soft magnetic metal powder prior to molding.

### (Soft Magnetic Metal Powder)

The soft magnetic metal powder according to the present embodiment may have a D50 of 3.0 μm or more and 30.0 μm or less. D50 is calculated from the equivalent circle diameters of all soft magnetic metal particles included in the soft magnetic metal powder. D50 is defined as the corresponding particle size at a number-based cumulative relative frequency of 50% (0.50).

Separately, from the soft magnetic metal particles included in the soft magnetic metal powder, all of those with a particle size of 5.0 μm or more are picked out. The number ratio of the soft magnetic metal particles with a particle size of 5.0 μm or more included in the soft magnetic metal powder according to the present embodiment is not limited. The number ratio may be, for example, 10% or more. In a situation where only the soft magnetic metal powder according to the present embodiment is used to manufacture a magnetic material, the soft magnetic metal particles with a particle size of 5.0 μm or more may account for 10% or more of the area of a section of the magnetic material.

The soft magnetic metal powder according to the present embodiment has a (y₉₅/y₅₀−y₉₀/y₅₀)/(0.95−0.90) of 20.0 or less, where y₉₅ (μm) denotes D95, y₉₀ (μm) denotes D90, and y₅₀ (μm) denotes D50 of a particle size distribution of the soft magnetic metal particles with a particle size of 5.0 μm or more.

In a particle size distribution of soft magnetic metal particles, D50 is the corresponding particle size at a number-based cumulative relative frequency of 50% (0.50); D90 is the corresponding particle size at a number-based cumulative relative frequency of 90% (0.90); and D95 is the corresponding particle size at a number-based cumulative relative frequency of 95% (0.95).

Using the soft magnetic metal powder whose (y₉₅/y₅₀−y₉₀/y₅₀)/(0.95−0.90) is 20.0 or less enables manufacture of a magnetic core having improved DC superimposition characteristics.

The meaning of the above formula is as follows. A coordinate plane having a horizontal axis representing the number-based cumulative relative frequency and a vertical axis representing the particle size standardized using D50 is determined. In such a coordinate plane, the above formula can be assumed to represent a slope of a line from a point denoting the particle size at a cumulative relative frequency of 0.90 to a point denoting the particle size at a cumulative relative frequency of 0.95. That is, the smaller the value represented by the above formula, the smaller the difference between the particle size at a cumulative relative frequency of 0.90 and the particle size at a cumulative relative frequency of 0.95.

In the particle size distribution of the soft magnetic metal powder, a portion corresponding to a number-based cumulative relative frequency of above 90% (0.90) has not conventionally been particularly focused. The present inventors have given attention to, in the soft magnetic metal powder, the soft magnetic metal particles with a particle size of 5.0 μm or more. In a situation where the soft magnetic metal powder is used for manufacture of a magnetic core, the soft magnetic metal particles with a particle size of 5.0 μm or more occupy a larger volume ratio per particle in the magnetic core than soft magnetic metal particles with a particle size of less than 5.0 μm. That is, the present inventors have given attention to the soft magnetic metal particles occupying a relatively large volume ratio per particle in the magnetic core. The present inventors have found that, in a situation where the magnetic core is manufactured using the soft magnetic metal powder having a small difference between the particle size at a cumulative relative frequency of 0.90 and the particle size at a cumulative relative frequency of 0.95 so that the particle size distribution of the soft magnetic metal particles with a particle size of 5.0 μm or more satisfies the above formula, DC superimposition characteristics of the magnetic core are improved.

Hereinafter, (y₉₅/y₅₀−y₉₀/y₅₀)/(0.95−0.90) may simply be referred to as “A1”.

The present inventors assume that a reason why A1 being small improves DC superimposition characteristics is as follows.

The sharper the particle size distribution of the soft magnetic metal particles included in the magnetic core, the less readily magnetic saturation of the magnetic core occurs. Focusing on the individual soft magnetic metal particles included in the magnetic core, the soft magnetic metal particles having a larger particle size are more readily magnetically saturated than the soft magnetic metal particles having a smaller particle size. This is because, the larger the particle sizes of the soft magnetic metal particles, the more readily a magnetic flux passes through the soft magnetic metal particles. Thus, in order to make it difficult for magnetic saturation to occur, it is important that the particle size distribution of the soft magnetic metal particles having a large particle size is sharp. Thus, examining the particle size distribution of the soft magnetic metal particles with a particle size of 5.0 μm or more is important. Further, it is assumed that, among the soft magnetic metal particles with a particle size of 5.0 μm or more, those having a particularly large particle size are readily magnetically saturated.

Inductors in general include a magnetic core. Standards used for inductors mention, as an index of their DC superimposition characteristics, a current value at which inductance is reduced by 10% from inductance at which no direct current is applied. Instead of inductance, relative permeability may be used.

Because magnetic saturation of the particularly large soft magnetic metal particles among the soft magnetic metal particles included in the magnetic core readily occurs, the particularly large soft magnetic metal particles dominantly affect the current value at which inductance is reduced by 10%. Thus, the particle size distribution of the soft magnetic metal particles having a particularly large particle size among the soft magnetic metal particles included in the magnetic core dominantly affects DC superimposition characteristics of an inductor including the magnetic core.

Considering the above, the present inventors have focused on the soft magnetic metal particles at a cumulative relative frequency of 0.90 to 0.95 in the particle size distribution of the soft magnetic metal particles with a particle size of 5.0 μm or more. It is assumed that, in a situation where A1 is small, i.e., in a situation where the particle size distribution of the particles at a cumulative relative frequency of 0.90 to 0.95 is sharp, magnetic saturation can particularly be prevented or mitigated. It is consequently assumed that DC superimposition characteristics of the inductor including the magnetic core manufactured using the soft magnetic metal particles having a small A1 are improved.

The soft magnetic metal powder according to the present embodiment may have any composition. Examples of such compositions include compositions that readily have an amorphous structure (e.g., Fe—Co—B—P—Si—Cr based, Fe—Si—B based, Fe—Si—B—C based, Fe—Si—B—C—Cr based, Fe—Co—P—C based, Fe—Co—B based, and Fe—Co—B—Si based compositions); compositions that readily have a nanocrystalline structure (e.g., Fe—Si—B—Nb—Cu based, Fe—Si—B—Nb—P based, Fe—Co—B—P—Si based, and Fe—Co—B—P—Si—Cr based compositions); and compositions that readily have a crystalline structure (e.g., Fe—Si based, Fe based, Fe—Ni based, Fe—Si—Cr based, Fe—Si—Al based, Fe—Si—Al—Ni based, Fe—Ni—Si—Co based, Fe—Co based, Fe—Co—V based, Fe—Co—Si based, and Fe—Co—Si—Al based compositions).

The soft magnetic metal powder according to the present embodiment may have any microstructure. The microstructure may be an amorphous structure, a nanocrystalline structure, or a crystalline structure.

Amorphous structures refer to structures having an amorphous ratio X of 85% or more. The amorphous structures include a structure in which crystals are contained to the extent that the amorphous ratio remains 85% or more. The amorphous structures include an approximately amorphous structure or a hetero-amorphous structure. A hetero-amorphous structure refers to a structure in which crystals are present in an amorphous solid. In the hetero-amorphous structure, the crystals present in the amorphous solid may have an average crystal grain size of 0.1 nm or more and 10 nm or less. A nanocrystalline structure refers to a structure having an amorphous ratio X of less than 85% and an average crystal grain size of 100 nm or less. The average crystal grain size of crystals in the nanocrystalline structure may be 3 nm or more and 50 nm or less. A crystalline structure refers to a structure having an amorphous ratio X of less than 85% and an average crystal grain size of above 100 nm.

The amorphous ratio X can be measured using an X-ray crystal structure analysis with XRD or may be measured using EBSD (crystal orientation analysis) or electron diffraction. A method of measuring the amorphous ratio using an X-ray crystal structure analysis with XRD is described below.

The amorphous ratio X of the soft magnetic metal powder is represented by Formula 1 shown below.

$$X = 100 - ( Ic / ( Ic + Ia ) \times 100 ) \qquad Formula 1$$

Ic: Crystal scattering integrated intensity
Ia: Amorphous scattering integrated intensity

The amorphous ratio X is calculated as follows. An X-ray crystal structure analysis of the soft magnetic metal powder using XRD is performed. In the analysis, phases are identified, and peaks (Ic: crystal scattering integrated intensity, Ia: amorphous scattering integrated intensity) of crystallized Fe or a crystallized compound are read. From the intensities of these peaks, the crystallization ratio is determined, and the amorphous ratio X is calculated using the above Formula 1. A method of calculation is more specifically described below.

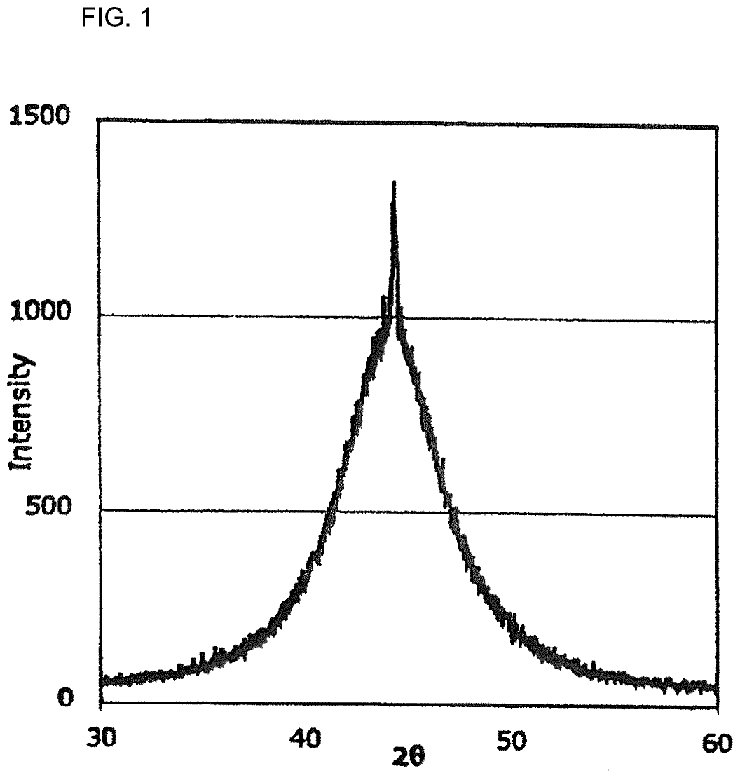

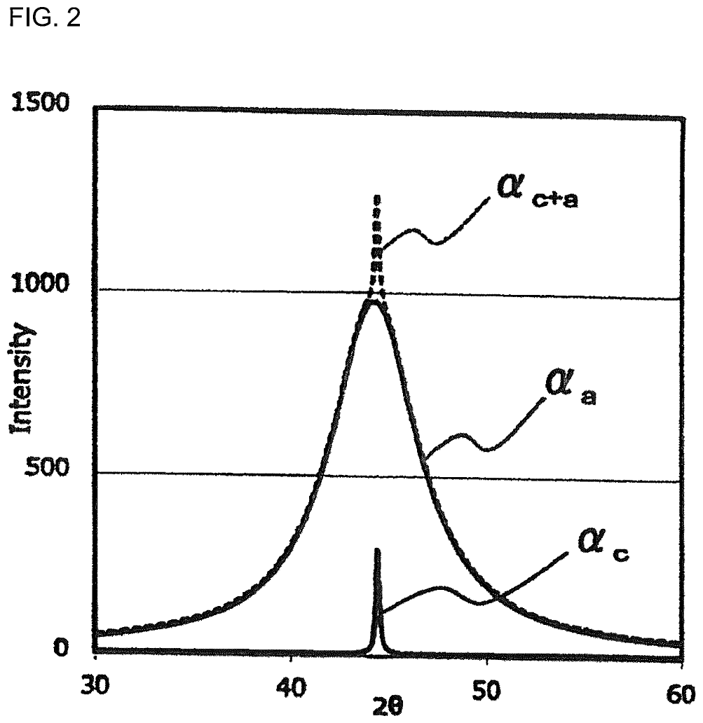

The X-ray crystal structure analysis of the soft magnetic metal powder using XRD is performed to generate a chart like the one shown as FIG. 1. Then, profile fitting is performed to this chart using a Lorentzian function shown as Formula 2 below to generate a crystal component pattern α_{c} showing the crystal scattering integrated intensity, an amorphous component pattern αₐ showing the amorphous scattering integrated intensity, and a pattern α_{c+a} showing a combination of these patterns, as shown in FIG. 2. From the patterns of the crystal scattering integrated intensity and the amorphous scattering integrated intensity, the amorphous ratio X is calculated using the above Formula 1. Note that the range of measurement is within a diffraction angle of 2θ=30° to 60°, in which a halo derived from amorphousness can be confirmed. In this range, the difference between the experimental integrated intensities measured using XRD and the integrated intensities calculated using the Lorentzian function is 1% or less.

$$f ( x ) = \frac{h}{1 + \frac{{( x - u )}^{2}}{{w}^{2}}} + b \qquad Formula 2$$

h: Peak height
u: Peak position
w: Full width at half maximum
b: Background height

The soft magnetic metal particles included in the soft magnetic metal powder may have a coating. The coating may be of any type and can be appropriately selected according to a purpose. Examples of coatings include oxide glass, phosphates, and SiO₂. Examples of oxide glass include P—Zn—Al—O based oxide glass, Bi—Zn—B—Si—O based oxide glass, and Ba—Zn—B—Si—Al—O based oxide glass. The coating of each soft magnetic metal particle may have any coating thickness. The coating thickness may be, for example, 0 nm or more and 200 nm or less. The coating thickness of the soft magnetic metal particles included in the soft magnetic metal powder may average 0 nm or more and 200 nm or less.

### (Magnetic Core)

Using the soft magnetic metal powder according to the present embodiment to manufacture a magnetic core enables the magnetic core to have improved DC superimposition characteristics.

The soft magnetic metal particles included in the magnetic core according to the present embodiment may have any composition. The composition may be similar to that of the soft magnetic metal powder according to the present embodiment.

The soft magnetic metal particles included in the magnetic core according to the present embodiment may have any microstructure. The microstructure may be an amorphous structure, a nanocrystalline structure, or a crystalline structure.

The magnetic core according to the present embodiment includes the soft magnetic metal particles included in the soft magnetic metal powder described above. The magnetic core may also include soft magnetic metal particles other than the soft magnetic metal particles included in the soft magnetic metal powder described above. The magnetic core may include, for example, soft magnetic metal particles having an average particle size smaller than that of the soft magnetic metal particles included in the soft magnetic metal powder described above. The soft magnetic metal particles having the smaller average particle size may have any composition. The soft magnetic metal particles having the smaller average particle size may have, for example, an Fe based, Fe—Ni based, Fe—Si based, or Fe—Co based composition.

The soft magnetic metal particles having the smaller average particle size may have a composition and a crystal structure similar to those of the soft magnetic metal particles included in the soft magnetic metal powder described above. Examples of such compositions include compositions that readily have an amorphous structure (e.g., Fe—Co—B—P—Si—Cr based, Fe—Si—B based, Fe—Si—B—C based, Fe—Si—B—C—Cr based, Fe—Co—P—C based, Fe—Co—B based, and Fe—Co—B—Si based compositions); compositions that readily have a nanocrystalline structure (e.g., Fe—Si—B—Nb—Cu based, Fe—Si—B—Nb—P based, Fe—Co—B—P—Si based, and Fe—Co—B—P—Si—Cr based compositions); and compositions that readily have a crystalline structure (e.g., Fe—Si based, Fe based, Fe—Ni based, Fe—Si—Cr based, Fe—Si—Al based, Fe—Si—Al—Ni based, Fe—Ni—Si—Co based, Fe—Co based, Fe—Co—V based, Fe—Co—Si based, and Fe—Co—Si—Al based compositions).

The various soft magnetic metal particles may have a coating. The coating may be of any type and can be appropriately selected according to a purpose. Examples of coatings include oxide glass, phosphates, and SiO₂. Examples of oxide glass include P—Zn—Al—O based oxide glass, Bi—Zn—B—Si—O based oxide glass, and Ba—Zn—B—Si—Al—O based oxide glass. Soft magnetic metal particles with a particle size of 5.0 μm or more described later may particularly have a coating thickness of, for example, 0 nm or more and 200 nm or less. The soft magnetic metal particles with a particle size of 5.0 μm or more described later may have an average coating thickness of 0 nm or more and 200 nm or less.

In the magnetic core according to the present embodiment, a magnetic material may account for an area ratio of 70% or more and 95% or less of a section of the magnetic core. In the magnetic material, various magnetic materials, such as the soft magnetic metal particles included in the soft magnetic metal powder described above, are included. The magnetic core according to the present embodiment may also include a resin other than the magnetic material. The resin may be of any type, and the amount of the resin is not limited. Examples of resins include thermosetting resins, such as a phenol resin and an epoxy resin. With respect to a total mass of 100 parts by mass of the various magnetic materials, the amount of the resin in the magnetic core may be 1.0 parts by mass or more and 5.0 parts by mass or less.

The magnetic core according to the present embodiment may include non-magnetic particles other than the above magnetic material and the resin to the extent that DC superimposition characteristics are suitably maintained. The magnetic core may include, for example, a modifier, a preservative, or a dispersant.

The soft magnetic metal particles with a particle size of 5.0 μm or more may account for any area ratio of the area of the magnetic material in a section of the magnetic core. The area ratio may be, for example, 10% or more and 100% or less, or 15% or more and 100% or less.

The composition of the magnetic material in a section of the magnetic core can be analyzed using, for example, EDS or an EPMA. In a situation where the magnetic core includes magnetic materials with different compositions, the respective compositions of the magnetic materials can be identified.

From the soft magnetic metal particles included in the magnetic core, all of those with a particle size (Heywood diameter) of 5.0 μm or more are picked out. Provided that the particle size is 5.0 μm or more, even those other than the soft magnetic metal particles included in the soft magnetic metal powder described above are picked out.

The magnetic core according to the present embodiment has a (Y₉₅/Y₅₀−Y₉₀/Y 50)/(0.95−0.90) of 20.0 or less, where Y₉₅ (μm) denotes D95, Y₉₀ (μm) denotes D90, and Y₅₀ (μm) denotes D50 of a particle size distribution of the soft magnetic metal particles with a particle size of 5.0 μm or more.

Having a (Y₉₅/Y₅₀−Y₉₀/Y₅₀)/(0.95−0.90) of 20.0 or less, the magnetic core has improved DC superimposition characteristics.

In a particle size distribution of the soft magnetic metal particles included in the magnetic core, a portion corresponding to a number-based cumulative relative frequency of above 90% (0.90) has not conventionally been particularly focused. Focusing on the soft magnetic metal particles with a particle size of 5.0 μm or more, the present inventors have found that DC superimposition characteristics of the magnetic core are improved when the difference between the particle size at a cumulative relative frequency of 0.90 and the particle size at a cumulative relative frequency of 0.95 in the particle size distribution of the soft magnetic metal particles with a particle size of 5.0 μm or more is small so that (Y₉₅/Y₅₀−Y₉₀/Y₅₀)/(0.95−0.90) is 20.0 or less, where Y₉₅ (μm) denotes D95, Y₉₀ (μm) denotes D90, and Y₅₀ (μm) denotes D50 of the particle size distribution of the soft magnetic metal particles with a particle size of 5.0 μm or more.

Hereinafter, (Y₉₅/Y₅₀−Y₉₀/Y 50)/(0.95−0.90) may simply be referred to as “A2”.

The present inventors assume that a reason why A2 being small improves DC superimposition characteristics is similar to the reason why A1 being small improves DC superimposition characteristics.

A magnetic core manufactured by press molding the soft magnetic metal powder according to the present embodiment readily becomes the magnetic core according to the present embodiment. Provided that relative permeability u is the same between the magnetic core according to the present embodiment and a conventional magnetic core molded at different molding pressures, the former magnetic core has higher DC superimposition characteristics. The relative permeability u of the magnetic core is not limited.

A method of manufacturing the soft magnetic metal powder according to the present embodiment is described below.

The soft magnetic metal powder can be manufactured using various melting methods. The soft magnetic metal powder may be manufactured using a method involving rapid quenching of a molten metal, because rapid quenching readily gives a soft magnetic metal powder having an amorphous structure. The soft magnetic metal powder can be manufactured using, for example, an atomization method. A method of manufacturing the soft magnetic metal powder using a gas atomization method, which is one type of atomization methods, is described below.

First, raw materials (e.g., pure metals) of constituent elements of the soft magnetic metal powder are prepared and are weighed to satisfy an intended soft magnetic metal composition. The raw materials of the constituent elements are melted to give a master alloy. Any melting method may be used. The raw materials of the constituent elements may be melted using, for example, high-frequency heating in a chamber at a predetermined degree of vacuum.

Then, the master alloy is heated for melting to give a molten metal. The temperature of the molten metal is determined in view of the melting point of the alloy having the intended composition. The temperature may be, for example, 1200° C. to 1600° C.

In a situation where the gas atomization method is used to give the soft magnetic metal powder, after the molten metal at 1200° C. to 1600° C. is obtained, the molten metal is sprayed in a chamber to give a powder. Specifically, the molten metal is discharged from a discharge port to a cooling portion of the chamber. At that time, a high-pressure gas is injected to the discharged molten metal. Jets of the high-pressure gas scatter the molten metal in the chamber. Colliding with the cooling portion (cooling water), the scattered molten metal is rapidly quenched and solidified to become the soft magnetic metal powder.

The high-pressure gas may be of any type. Examples of such gases include inert gases, such as a nitrogen gas, an argon gas, and a helium gas. The high-pressure gas may also be a reducing gas, such as an ammonia decomposition gas.

The pressure of the injected high-pressure gas is not limited. The pressure may be 2.0 to 10.0 MPa. The spray amount of the discharged molten metal is not limited. The spray amount may be 0.5 to 4.0 kg/min. Controlling the ratio of the pressure of the high-pressure gas to the spray amount of the molten metal can control the particle size or the like of the soft magnetic metal powder.

An atomization apparatus used for the gas atomization method may be an elliptical water flow atomization apparatus capable of generating a cooling water flow in an elliptical spiral.

The particle size of the resultant soft magnetic metal powder may be controlled using dry classification or wet classification. Examples of dry classification methods include sieve classification using a dry sieve and air flow classification utilizing differences in mechanical behaviors. Wet classification is carried out in liquid using centrifugal force, gravity, etc. Examples of wet classification methods include wet filtration classification using a filter and classification by centrifuging.

In order to obtain the soft magnetic metal powder according to the present embodiment, i.e., in order to reduce the difference between the particle size at a cumulative relative frequency of 0.90 and the particle size at a cumulative relative frequency of 0.95 for reduction of A1, two or more different classification methods are carried out in sequence. Further, at the time of carrying out the two or more different classification methods in sequence, a cut size (cut point) may substantially be the same between or among the classification methods. The cut size is substantially the same between a last classification method and a second to last classification method, which are at least different from each other.

The cut size in terms of classifying the soft magnetic metal powder means D50 of the soft magnetic metal powder. The cut size being substantially the same between or among the two or more different classification methods carried out in sequence denotes that a quotient of the cut size of a latter classification method divided by the cut size of a former classification method is 0.9 or more.

It has conventionally been assumed that carrying out two or more different classification methods in sequence itself is not preferred because they cost money for manufacture. In particular, it has been assumed that making the cut size substantially the same between or among the classification methods renders a latter classification method meaningless and only simply increases manufacturing costs.

However, the present inventors have found that easiness of removing particles having the same particle size varies depending on classification methods. For example, in sieve classification, deformed particles having a needle-like shape are relatively readily removed. In air flow classification, deformed particles having a flat shape are relatively readily removed. In wet classification, particles having a high specific gravity are relatively readily removed.

In a situation where the cut size is substantially the same between or among the two or more different classification methods carried out in sequence, the particles with a particle size smaller than D90 are almost not removed in the second and the subsequent classification methods; and the particles with a particle size of about D90 or more are partly removed in the second and the subsequent classification methods only if these particles are of a type that is removed more readily by the second and the subsequent classification methods than by the first classification method. Consequently, the difference between the particle size at a cumulative relative frequency of 0.90 and the particle size at a cumulative relative frequency of 0.95 is reduced for reduction of A1.

The soft magnetic metal powder according to the present embodiment may be provided with an insulation film. To provide surfaces of the soft magnetic metal particles included in the soft magnetic metal powder with the insulation film, a film formation treatment (e.g., heat treatment, phosphate treatment, mechanical alloying, silane coupling treatment, or hydrothermal synthesis) may be carried out for the soft magnetic metal powder.

The soft magnetic metal powder according to the present embodiment may be used for any purpose. The soft magnetic metal powder can be applied to various magnetic components. The soft magnetic metal powder can suitably be included as a material of a magnetic core of magnetic components such as, in particular, an inductor, a transformer, and a choke coil.

The magnetic core according to the present embodiment may be of any type. The following description is provided on the premise that the magnetic core is a dust core. That is, a method of manufacturing the magnetic core by press molding is described below.

Any method of manufacturing the magnetic core may be used. For example, first, the soft magnetic metal powder according to the present embodiment and a resin are kneaded to give a resin compound. The resin compound may be a granulated powder. At this time, for example, a soft magnetic metal powder other than the soft magnetic metal powder according to the present embodiment and/or a non-magnetic powder may be added to the resin compound. A modifier, a preservative, a dispersant, etc. may also be added. A mold is then filled with the resin compound. Press molding is carried out. Then, the resin is cured to give the magnetic core.

First, the soft magnetic metal powder and the resin are mixed. Mixing the powder with the resin makes it easier to give a pressed body having high strength by molding. The resin may be of any type. Examples of resins include a phenol resin and an epoxy resin. The amount of the resin added is not limited. With respect to a total mass of 100 parts by mass of various magnetic materials, the amount of the resin may be 1.0 parts by mass or more and 5.0 parts by mass or less.

The mixture of the soft magnetic metal powder and the resin is granulated to give a granulated powder. Any method of granulation may be used. For example, a stirrer may be used for granulation. The granulated powder may have any particle size.

The granulated powder is press molded to give the pressed body. The molding pressure is not limited. For example, the pressure (surface pressure) may be 0.1 t/cm² or more and 20 t/cm² or less. In a situation where the soft magnetic metal powder manufactured with an elliptical water flow atomization apparatus is used, relative permeability u can be increased at a relatively smaller molding pressure than when a powder manufactured using a conventional atomizing apparatus is used.

Curing the resin included in the pressed body can give the magnetic core. Any curing method may be used. A heat treatment may be carried out under conditions that can cure the resin. Using the soft magnetic metal powder having an A1 of 20.0 or less and appropriately controlling the amount of the soft magnetic metal powder added other than the soft magnetic metal powder according to the present embodiment enable the magnetic core to have an A2 of 20.0 or less.

The magnetic core may be used for any purpose. The magnetic core can be suitably used as, for example, a magnetic core of an inductor.

Further, the above magnetic core or a magnetic component including the above magnetic core can be suitably used for an electronic device.

In particular, for readily having relatively high DC superimposition characteristics, the above magnetic core is suitably used in fields in need of smaller size or smaller height. The magnetic core can be suitably used as or included in, for example, a magnetic core, a magnetic component, or an electronic device included in a DC-DC converter.

### EXAMPLES

Hereinafter, the present invention is specifically described based on examples.

### Experiment 1

### <Soft Magnetic Metal Powder>

Various raw materials were weighed so that a soft magnetic metal composition was 57.4Fe-24.6Co-11.0B-3.0P-3.0Si-1.0Cr in atomic mass ratio and were melted by high-frequency heating to give a master alloy. The weighed raw materials were melted by high-frequency heating in a vacuumed chamber to give the master alloy.

The master alloy was heated and melted to give a metal in a molten state having a temperature of 1200° C. or more and 1600° C. or less. Then, a gas atomization method was used to manufacture a soft magnetic metal powder having an alloy composition of each sample. Specifically, at the time when the molten master alloy was discharged from a discharge port to a cooling portion (cooling water) of a chamber, a high-pressure gas was injected to the discharged molten metal droplets. The high-pressure gas was an argon gas. The molten metal droplets collided with the cooling portion (cooling water) for rapid quenching and solidification to give the soft magnetic metal powder.

Conditions of the gas atomization method were as follows. The pressure of the high-pressure gas was 2.0 MPa or more and 10 MPa or less. The sprayed amount of the molten metal was 0.5 kg/min or more and 4.0 kg/min or less. The above conditions were appropriately controlled so that the intended soft magnetic metal powder was obtained. Using an ICP analysis, it was confirmed that, in each sample, the composition of the master alloy and the composition of the powder approximately corresponded. X-ray diffraction measurement was carried out for each powder to measure its amorphous ratio X. When the amorphous ratio X was 85% or more, the powder was deemed to have an amorphous structure. When the amorphous ratio X was less than 85% and the average crystal grain size was 100 nm or less, the powder was deemed to have a nanocrystalline structure. When the amorphous ratio X was less than 85% and the average crystal grain size exceeded 100 nm, the powder was deemed to have a crystalline structure. In Experiment 1, it was confirmed that all the soft magnetic metal powders had an amorphous structure.

Then, a coating treatment was carried out for each soft magnetic metal powder using a mechanofusion system (AMS-Lab manufactured by Hosokawa Micron Group) to provide surfaces of the powder with a P—Zn—Al—O based oxide glass coating. The coating had a thickness of 15 nm.

Then, sieve classification, air flow classification, and/or wet classification were carried out in the order shown in Table 1.

As sieve classification, the powder was classified in air using a dry sieve. A cut size was controlled by changing the powder feed amount per feed, classification time, and/or mesh size of the sieve.

For air flow classification, a rotor-rotating type classification apparatus was used. A cut size was controlled by changing the powder input amount, rotation speed, and/or air volume.

Wet classification was carried out by classifying the powder in liquid. As a classification apparatus, a filter-type wet classification apparatus was used. A cut size was controlled by changing the aperture size of a filter, concentration of a magnetic material, and/or push flow rate.

In the samples shown in Table 1, when classification was carried out for two or more times, the cut size was substantially the same between or among the two or more times of classification.

In the samples shown in Table 2, the cut size of a second classification method was smaller than the cut size of a first classification method. Specifically, in Sample Nos. 25 to 27, a powder that went through the classification of Sample No. 22 was subjected to the corresponding second classification method. In Sample Nos. 28 to 30, a powder that went through the classification of Sample No. 23 was subjected to the corresponding second classification method. In Sample Nos. 31 to 33, a powder that went through the classification of Sample No. 24 was subjected to the corresponding second classification method.

Then, y₅₀, y₉₀, and y₉₅ of the soft magnetic metal powder of each sample were measured. First, individual particle projections were observed with Morphologi G3 (Malvern Panalytical). The shapes of 20,000 particles were observed at a magnification of ×10. Specifically, 3 cc (volume) of the powder was dispersed at an air pressure of 1 to 3 bar to take the projections with a laser microscope. The projected area diameters of the particles in the projections were measured as their particle sizes. From the particle sizes of the particles, y₅₀, y₉₀, and y₉₅ were calculated. Then, A1 was calculated.

In each sample of Experiment 1, D50 of a particle size distribution of all soft magnetic metal particles included in the soft magnetic metal powder was about 6 μm.

### <Small Particle Powder>

In Experiment 1, an Fe powder was prepared as a small particle powder as shown in Tables 1 and 2. Small particles had an average particle size of 1 μm. In Experiment 1, these small particles included in the small particle powder were soft magnetic metal particles different from large particles included in a large particle powder.

### <Magnetic Core>

Using the soft magnetic metal powder (large particle powder) of each sample and the small particle powder, a toroidal core was manufactured.

First, the large particle powder, the small particle powder, and an epoxy resin were kneaded to give a resin compound. With respect to a total mass of 100 parts by mass of various magnetic materials, the amount of the epoxy resin was controlled to 2.5 parts by mass. The mixing ratio of the large particle powder to the small particle powder was controlled so that the area ratio of the large particles to the small particles described later was as shown in Tables 1 and 2. That is, the mixing ratio was controlled so that the area ratio (the area of the large particles:the area of the small particles) was about 80:20.

A mold was filled with the resin compound, and pressure was applied thereto, to give a pressed body having a toroidal shape. The molding pressure was controlled so that the toroidal core eventually obtained had a relative permeability μ0 (relative permeability at which a DC magnetic field was not being applied) of about 30.

The toroidal pressed body was subject to a heat treatment at 180° C. for 60 minutes for curing the epoxy resin included in the pressed body to give the toroidal core. The toroidal core had an outside diameter of 11 mm, an inside diameter of 6.5 mm, and a thickness of 2.5 mm. As many number of toroidal cores as necessary for tests described later were manufactured.

A2 in a section of the toroidal core, the area ratio of the magnetic materials, and the area ratio of the large particles to the small particles were measured.

First, any part of the toroidal core was cut off. Then, a SEM image at a magnification (×100 to ×1000) at which whether particles in the resulting section of the toroidal core were the large particles attributed to the large particle powder or the small particles attributed to the small particle powder could be determined was observed. The SEM image included at least 2,000 large particles. The area ratio of the large particles to the small particles was calculated. Tables 1 and 2 show the results. As for particles that were difficult to determine whether they were the large particles or the small particles using only the SEM image, an elemental mapping with EDS or the like was used together for distinction.

Through an analysis of the SEM image, Heywood diameters of the soft magnetic metal particles were measured from their shapes. As software used for the image analysis, Mac-View (manufactured by MOUNTECH Co., Ltd.) was used. From the Heywood diameters of the soft magnetic metal particles, a particle size distribution of the soft magnetic metal particles with a Heywood diameter of 5.0 μm or more was calculated. Then, Y₅₀, Y₉₀, and Y₉₅ were calculated to calculate A2. In all Examples shown below, it was confirmed that A2 was 20.0 or less. In all Comparative Examples shown below, it was confirmed that A2 exceeded 20.0.

Relative permeability μ0 of the toroidal core of each sample was measured using the following method. First, a polyurethane copper wire (UEW wire) was wound around the toroidal core. Inductance of the toroidal core was measured with an LCR meter (4284A manufactured by Agilent Technologies) at a frequency of 1 MHz without application of a direct current. From the inductance, relative permeability μ0 was calculated. Tables 1 and 2 show the results.

Further, Isat of the toroidal core of each sample was measured to evaluate its DC superimposition characteristics. As the direct current applied to the toroidal core of each sample was increased, its relative permeability decreased. The value of a direct current at which relative permeability was reduced from μ0 by 10% during measurement of relative permeability of the toroidal core with application of a direct current was defined as Isat. Tables 1 and 2 show the results.

Further, Isat of Sample No. 1, which was under the same conditions as Sample Nos. 2 to 21 and 25 to 33 except that sieve classification was carried out only once, was used as a benchmark; and a ratio of Isat of each sample to Isat of Sample No. 1 was defined as an Isat ratio. At an Isat ratio of 1.10 or more, DC superimposition characteristics were regarded as good. Tables 1 and 2 show the results. As for Sample Nos. 22 to 24, their Isat ratios were not calculated.

TABLE 1

| | | Soft magnetic metal powder | | | | | | | | | | | | | |
|---|---|---|---|---|---|---|---|---|---|---|---|---|---|---|---|
| | | | | | | Particle size | | | | | | | | | |
| | | | | | | distribution of | | | | | | | | | |
| | | | | | | particles having a | | | | Magnetic core | | | | | |
| Sam- | | Classification method | | | | particle size of | | | | Small | Area ratio | | | | |
| ple | Example/ | | | | Cut | 5.0 μm or more | | | | particle | Large | Small | | Isat | Isat |
| No. | Comparative Example | 1st | 2nd | 3rd | size | y₅₀ | y₉₀ | y₉₅ | A1 | type | particles | particles | μ0 | (A) | ratio |
| 1 | Comparative Example | Sieve | — | — | — | 7.5 | 20.1 | 29.0 | 23.7 | Fe | 79.3 | 20.7 | 30.0 | 9.8 | 1.00 |
| 2 | Comparative Example | Air flow | — | — | — | 7.5 | 20.3 | 28.9 | 22.9 | Fe | 80.7 | 19.3 | 30.5 | 9.9 | 1.01 |
| 3 | Comparative Example | Wet | — | — | — | 7.5 | 20.4 | 29.1 | 23.2 | Fe | 80.6 | 19.4 | 29.8 | 9.8 | 1.00 |
| 4 | Comparative Example | Sieve | Sieve | — | Same | 7.5 | 19.8 | 28.7 | 23.7 | Fe | 79.0 | 21.0 | 30.1 | 9.6 | 0.98 |
| 5 | Comparative Example | Air flow | Air flow | — | Same | 7.5 | 20.1 | 28.7 | 22.9 | Fe | 79.6 | 20.4 | 29.9 | 9.7 | 0.99 |
| 6 | Comparative Example | Wet | Wet | — | Same | 7.5 | 20.3 | 28.9 | 22.9 | Fe | 81.2 | 18.8 | 29.6 | 9.8 | 1.00 |
| 7 | Example | Sieve | Air flow | — | Same | 7.5 | 20.3 | 27.3 | 18.7 | Fe | 78.5 | 21.5 | 29.6 | 10.8 | 1.10 |
| 8 | Example | Sieve | Wet | — | Same | 7.5 | 20.1 | 25.8 | 15.2 | Fe | 80.1 | 19.9 | 30.2 | 11.5 | 1.17 |
| 9 | Example | Air flow | Sieve | — | Same | 7.5 | 20.4 | 27.8 | 19.7 | Fe | 80.0 | 20.0 | 30.3 | 10.9 | 1.11 |
| 10 | Example | Air flow | Wet | — | Same | 7.5 | 20.1 | 24.8 | 12.5 | Fe | 79.1 | 20.9 | 30.0 | 12.1 | 1.23 |
| 11 | Example | Wet | Sieve | — | Same | 7.5 | 19.5 | 25.8 | 16.8 | Fe | 78.7 | 21.3 | 30.2 | 11.5 | 1.17 |
| 12 | Example | Wet | Air flow | — | Same | 7.5 | 19.7 | 24.5 | 12.8 | Fe | 79.7 | 20.3 | 29.7 | 12.1 | 1.23 |
| 13 | Comparative Example | Sieve | Sieve | Sieve | Same | 7.5 | 20.4 | 28.8 | 22.4 | Fe | 80.5 | 19.5 | 30.4 | 9.8 | 1.00 |
| 14 | Comparative Example | Air flow | Air flow | Air flow | Same | 7.5 | 20.0 | 28.6 | 22.9 | Fe | 80.5 | 19.5 | 30.3 | 9.9 | 1.01 |
| 15 | Comparative Example | Wet | Wet | Wet | Same | 7.5 | 20.2 | 28.9 | 23.2 | Fe | 80.2 | 19.8 | 30.3 | 9.8 | 1.00 |
| 16 | Example | Sieve | Air flow | Wet | Same | 7.5 | 19.7 | 22.9 | 8.5 | Fe | 79.8 | 20.2 | 30.4 | 12.3 | 1.26 |
| 17 | Example | Sieve | Wet | Air flow | Same | 7.5 | 20.0 | 22.8 | 7.5 | Fe | 80.5 | 19.5 | 30.2 | 12.4 | 1.27 |
| 18 | Example | Air flow | Sieve | Wet | Same | 7.5 | 19.9 | 21.9 | 5.3 | Fe | 80.9 | 19.1 | 30.0 | 12.8 | 1.31 |
| 19 | Example | Air flow | Wet | Sieve | Same | 7.5 | 20.2 | 22.0 | 4.8 | Fe | 81.1 | 18.9 | 30.4 | 12.8 | 1.31 |
| 20 | Example | Wet | Sieve | Air flow | Same | 7.5 | 20.2 | 21.2 | 2.7 | Fe | 80.9 | 19.1 | 30.2 | 13.1 | 1.34 |
| 21 | Example | Wet | Air flow | Sieve | Same | 7.5 | 19.6 | 20.9 | 3.5 | Fe | 79.6 | 20.4 | 29.9 | 13.0 | 1.33 |

TABLE 2

| | | Soft magnetic metal powder | | | | | | | | | | | | | |
|---|---|---|---|---|---|---|---|---|---|---|---|---|---|---|---|
| | | | | | | Particle size | | | | | | | | | |
| | | | | | | distribution of | | | | | | | | | |
| | | | | | | particles having a | | | | Magnetic core | | | | | |
| Sam- | | Classification method | | | | particle size of | | | | Small | Area ratio | | | | |
| ple | Example/ | | | | Cut | 5.0 μm or more | | | | particle | Large | Small | | Isat | Isat |
| No. | Comparative Example | 1st | 2nd | 3rd | size | y₅₀ | y₉₀ | y₉₅ | A1 | type | particles | particles | μ0 | (A) | ratio |
| 22 | Comparative Example | Sieve | — | — | — | 10.4 | 22.4 | 34.4 | 23.1 | Fe | 81.3 | 18.7 | 31.1 | 8.9 | — |
| 23 | Comparative Example | Air flow | — | — | — | 10.5 | 22.4 | 34.8 | 23.6 | Fe | 81.4 | 18.6 | 31.2 | 8.8 | — |
| 24 | Comparative Example | Wet | — | — | — | 10.8 | 22.6 | 34.9 | 22.8 | Fe | 78.9 | 21.1 | 31.2 | 8.7 | — |
| 1 | Comparative Example | Sieve | — | — | — | 7.5 | 20.1 | 29.0 | 23.7 | Fe | 79.3 | 20.7 | 30.0 | 9.8 | 1.00 |
| 2 | Comparative Example | Air flow | — | — | — | 7.5 | 20.3 | 28.9 | 22.9 | Fe | 80.7 | 19.3 | 30.5 | 9.9 | 1.01 |
| 3 | Comparative Example | Wet | — | — | — | 7.5 | 20.4 | 29.1 | 23.2 | Fe | 80.6 | 19.4 | 29.8 | 9.8 | 1.00 |
| 25 | Comparative Example | Sieve | Sieve | — | Different | 7.4 | 20.4 | 29.0 | 23.2 | Fe | 79.3 | 20.7 | 29.7 | 9.8 | 1.00 |
| 26 | Comparative Example | Sieve | Air flow | — | Different | 7.6 | 20.3 | 28.9 | 22.6 | Fe | 78.8 | 21.2 | 30.2 | 9.7 | 0.99 |
| 27 | Comparative Example | Sieve | Wet | — | Different | 7.5 | 20.3 | 29.0 | 23.2 | Fe | 80.1 | 19.9 | 30.4 | 9.7 | 0.99 |
| 28 | Comparative Example | Air flow | Sieve | — | Different | 7.4 | 20.4 | 29.0 | 23.2 | Fe | 81.2 | 18.8 | 30.4 | 9.8 | 1.00 |
| 29 | Comparative Example | Air flow | Air flow | — | Different | 7.5 | 20.3 | 28.9 | 22.9 | Fe | 79.3 | 20.7 | 29.8 | 9.9 | 1.01 |
| 30 | Comparative Example | Air flow | Wet | — | Different | 7.5 | 20.3 | 29.0 | 23.2 | Fe | 80.3 | 19.7 | 30.1 | 9.7 | 0.99 |
| 31 | Comparative Example | Wet | Sieve | — | Different | 7.4 | 20.4 | 29.0 | 23.2 | Fe | 79.7 | 20.3 | 29.6 | 9.8 | 1.00 |
| 32 | Comparative Example | Wet | Air flow | — | Different | 7.5 | 20.4 | 29.1 | 23.2 | Fe | 79.5 | 20.5 | 29.7 | 9.8 | 1.00 |
| 33 | Comparative Example | Wet | Wet | — | Different | 7.5 | 20.3 | 29.2 | 23.7 | Fe | 81.0 | 19.0 | 29.7 | 9.6 | 0.98 |

According to Table 1, in each Example, in which two or more types of classification methods were carried out at the same cut size during manufacture of the soft magnetic metal powder, A1 was 20.0 or less. As described above, A2 was also 20.0 or less. Consequently, DC superimposition characteristics were good.

According to Table 1, in each Comparative Example, in which only one type of classification method was carried out during manufacture of the soft magnetic metal powder, A1 exceeded 20.0 regardless of the number of times of classification. As described above, A2 also exceeded 20.0. Consequently, no improvement of DC superimposition characteristics was seen.

According to Table 2, in each Comparative Example, in which two types of classification methods were carried out at different cut sizes during manufacture of the soft magnetic metal powder, A1 exceeded 20.0. As described above, A2 also exceeded 20.0. Consequently, no improvement of DC superimposition characteristics was seen.

It was confirmed that the particle size distribution (particularly A1) of the soft magnetic metal powder resulting from carrying out multiple times of classification using different classification methods at different cut sizes was not greatly different from the particle size distribution of the soft magnetic metal powder resulting from carrying out one time of classification at a minimum cut size.

### Experiment 2

Experiment 2 was conducted as in Sample Nos. 1 and 17 except that the mixing ratio of the large particle powder to the small particle powder was changed. The Isat ratio of each Example was calculated using, as a benchmark, Isat of the corresponding Comparative Example carried out under substantially the same conditions except that sieve classification was carried out once. Table 3 shows the results.

TABLE 3

| | | Soft magnetic metal powder | | | | | | | | | | | | |
|---|---|---|---|---|---|---|---|---|---|---|---|---|---|---|
| | | | | | Particle size | | | | | | | | | |
| | | | | | distribution of | | | | | | | | | |
| | | | | | particles having a | | | | Magnetic core | | | | | |
| | | | | | particle size of | | | | Small | Area ratio | | | | |
| Sample | Example/ | Classification method | | | 5.0 μm or more | | | | particle | Large | Small | | Isat | Isat |
| No. | Comparative Example | 1st | 2nd | 3rd | y₅₀ | y₉₀ | y₉₅ | A1 | type | particles | particles | μ0 | (A) | ratio |
| 34 | Comparative Example | Sieve | — | — | 7.5 | 20.1 | 29.0 | 23.7 | — | 100.0 | — | 25.2 | 12.1 | 1.00 |
| 35 | Example | Sieve | Wet | Air flow | 7.5 | 20.0 | 22.8 | 7.5 | — | 100.0 | — | 25.3 | 15.1 | 1.25 |
| 36 | Comparative Example | Sieve | — | — | 7.5 | 20.1 | 29.0 | 23.7 | Fe | 90.1 | 9.9 | 27.5 | 11.2 | 1.00 |
| 37 | Example | Sieve | Wet | Air flow | 7.5 | 20.0 | 22.8 | 7.5 | Fe | 89.9 | 10.1 | 27.4 | 14.1 | 1.26 |
| 1 | Comparative Example | Sieve | — | — | 7.5 | 20.1 | 29.0 | 23.7 | Fe | 79.3 | 20.7 | 30.0 | 9.8 | 1.00 |
| 17 | Example | Sieve | Wet | Air flow | 7.5 | 20.0 | 22.8 | 7.5 | Fe | 80.5 | 19.5 | 30.2 | 12.4 | 1.27 |
| 38 | Comparative Example | Sieve | — | — | 7.5 | 20.1 | 29.0 | 23.7 | Fe | 60.2 | 39.8 | 30.2 | 9.9 | 1.00 |
| 39 | Example | Sieve | Wet | Air flow | 7.5 | 20.0 | 22.8 | 7.5 | Fe | 60.3 | 39.7 | 30.4 | 12.6 | 1.27 |
| 40 | Comparative Example | Sieve | — | — | 7.5 | 20.1 | 29.0 | 23.7 | Fe | 40.2 | 59.8 | 27.8 | 11.8 | 1.00 |
| 41 | Example | Sieve | Wet | Air flow | 7.5 | 20.0 | 22.8 | 7.5 | Fe | 40.3 | 59.7 | 27.6 | 14.4 | 1.22 |
| 42 | Comparative Example | Sieve | — | — | 7.5 | 20.1 | 29.0 | 23.7 | Fe | 20.1 | 79.9 | 25.1 | 12.1 | 1.00 |
| 43 | Example | Sieve | Wet | Air flow | 7.5 | 20.0 | 22.8 | 7.5 | Fe | 20.3 | 79.7 | 25.1 | 14.8 | 1.22 |

In each Example, in which two or more types of classification methods were carried out at the same cut size during manufacture of the large particle powder, A1 was 20.0 or less despite the mixing ratio of the large particle powder to the small particle powder being changed. As described above, A2 was also 20.0 or less. Consequently, DC superimposition characteristics were good.

### Experiment 3

Experiment 3 was conducted as in Sample Nos. 1 and 17 except that the particle sizes of all the soft magnetic metal particles included in the soft magnetic metal powder were changed to change D50 of the particle size distribution of all the soft magnetic metal particles included in the soft magnetic metal powder and to change y₅₀, y₉₀, and y₉₅ at the same time. The Isat ratio of each Example was calculated using, as a benchmark, Isat of the corresponding Comparative Example carried out under substantially the same conditions except that sieve classification was carried out once. Table 4 shows the results.

TABLE 4

| | | Soft magnetic metal powder | | | | | | | | | | | | | |
|---|---|---|---|---|---|---|---|---|---|---|---|---|---|---|---|
| | | | | | | Particle size | | | | | | | | | |
| | | | | | | distribution of | | | | | | | | | |
| | | | | | D50 | particles having a | | | | Magnetic core | | | | | |
| | | | | | of all | particle size of | | | | Small | Area ratio | | | | |
| Sample | Example/ | Classification method | | | particles | 5.0 μm or more | | | | particle | Large | Small | | Isat | Isat |
| No. | Comparative Example | 1st | 2nd | 3rd | (μm) | y₅₀ | y₉₀ | y₉₅ | A1 | type | particles | particles | μ0 | (A) | ratio |
| 44 | Comparative Example | Sieve | — | — | 30.0 | 31.2 | 57.3 | 90.1 | 21.0 | Fe | 81.0 | 19.0 | 35.2 | 7.1 | 1.00 |
| 45 | Example | Sieve | Wet | Air flow | 30.0 | 31.2 | 57.4 | 78.2 | 13.3 | Fe | 81.0 | 19.0 | 35.2 | 8.9 | 1.25 |
| 46 | Comparative Example | Sieve | — | — | 20.1 | 24.9 | 50.3 | 78.9 | 23.0 | Fe | 79.8 | 20.2 | 32.2 | 8.1 | 1.00 |
| 47 | Example | Sieve | Wet | Air flow | 20.4 | 25.0 | 50.2 | 60.3 | 8.1 | Fe | 80.6 | 19.4 | 32.1 | 10.3 | 1.27 |
| 48 | Comparative Example | Sieve | — | — | 10.4 | 15.4 | 39.8 | 58.2 | 23.9 | Fe | 79.0 | 21.0 | 31.8 | 8.5 | 1.00 |
| 49 | Example | Sieve | Wet | Air flow | 10.5 | 15.0 | 39.6 | 45.3 | 7.6 | Fe | 80.7 | 19.3 | 31.8 | 10.7 | 1.26 |
| 22 | Comparative Example | Sieve | — | — | 7.8 | 10.4 | 22.4 | 34.4 | 23.1 | Fe | 81.3 | 18.7 | 31.1 | 8.9 | 1.00 |
| 50 | Example | Sieve | Wet | Air flow | 7.9 | 10.5 | 22.4 | 26.0 | 6.9 | Fe | 80.1 | 19.9 | 31.1 | 11.3 | 1.27 |
| 1 | Comparative Example | Sieve | — | — | 5.8 | 7.5 | 20.1 | 29.0 | 23.7 | Fe | 79.3 | 20.7 | 30.0 | 9.8 | 1.00 |
| 17 | Example | Sieve | Wet | Air flow | 5.9 | 7.5 | 20.0 | 22.8 | 7.5 | Fe | 80.5 | 19.5 | 30.2 | 12.4 | 1.27 |
| 51 | Comparative Example | Sieve | — | — | 4.4 | 5.4 | 15.2 | 22.2 | 25.9 | Fe | 79.8 | 20.2 | 28.5 | 10.3 | 1.00 |
| 52 | Example | Sieve | Wet | Air flow | 4.4 | 5.4 | 15.3 | 17.3 | 7.4 | Fe | 80.0 | 20.0 | 28.5 | 12.9 | 1.25 |
| 53 | Comparative Example | Sieve | — | — | 3.0 | 5.2 | 6.4 | 12.4 | 23.1 | Fe | 80.2 | 19.8 | 25.3 | 11.3 | 1.00 |
| 54 | Example | Sieve | Wet | Air flow | 3.0 | 5.1 | 6.6 | 9.8 | 12.5 | Fe | 79.6 | 20.4 | 25.3 | 14.6 | 1.29 |

In each Example, in which two or more types of classification methods were carried out at the same cut size during manufacture of the large particle powder, A1 was 20.0 or less despite the particle sizes of all the soft magnetic metal particles being changed. As described above, A2 was also 20.0 or less. Consequently, DC superimposition characteristics were good.

### Experiment 4

Experiment 4 was conducted as in Sample Nos. 1 and 17 except that the coating thickness was changed. The Isat ratio of each Example was calculated using, as a benchmark, Isat of the corresponding Comparative Example carried out under substantially the same conditions except that sieve classification was carried out once. Table 5 shows the results.

Although Table 5 does not show A1, it was confirmed that y₅₀, y₉₀, and y₉₅ of all Examples were about the same as those of Sample No. 17 and that A1 was 20.0 or less in all Examples. It was confirmed that y₅₀, y₉₀, and y₉₅ of all Comparative Examples were about the same as those of Sample No. 1 and that A1 exceeded 20.0 in all Comparative Examples.

TABLE 5

| | | Soft magnetic metal powder | | | | Magnetic core | | | | | |
|---|---|---|---|---|---|---|---|---|---|---|---|
| | | | | | Coating | Small | Area ratio | | | | |
| Sample | Example/ | Classification method | | | thickness | particle | Large | Small | | Isat | Isat |
| No. | Comparative Example | 1st | 2nd | 3rd | (nm) | type | particles | particles | μ0 | (A) | ratio |
| 55 | Comparative Example | Sieve | — | — | 0 | Fe | 78.8 | 21.2 | 33.0 | 8.1 | 1.00 |
| 56 | Example | Sieve | Wet | Air flow | 0 | Fe | 81.2 | 18.8 | 33.1 | 10.1 | 1.25 |
| 57 | Comparative Example | Sieve | — | — | 5 | Fe | 79.1 | 20.9 | 32.1 | 9.0 | 1.00 |
| 58 | Example | Sieve | Wet | Air flow | 5 | Fe | 81.0 | 19.0 | 32.1 | 11.3 | 1.26 |
| 1 | Comparative Example | Sieve | — | — | 15 | Fe | 79.3 | 20.7 | 30.0 | 9.8 | 1.00 |
| 17 | Example | Sieve | Wet | Air flow | 15 | Fe | 80.5 | 19.5 | 30.2 | 12.4 | 1.27 |
| 59 | Comparative Example | Sieve | — | — | 50 | Fe | 81.4 | 18.6 | 29.2 | 10.1 | 1.00 |
| 60 | Example | Sieve | Wet | Air flow | 50 | Fe | 78.6 | 21.4 | 29.3 | 12.7 | 1.26 |
| 61 | Comparative Example | Sieve | — | — | 100 | Fe | 81.2 | 18.8 | 28.2 | 10.4 | 1.00 |
| 62 | Example | Sieve | Wet | Air flow | 100 | Fe | 81.2 | 18.8 | 28.1 | 13.2 | 1.27 |
| 63 | Comparative Example | Sieve | — | — | 150 | Fe | 78.6 | 21.4 | 27.2 | 11.1 | 1.00 |
| 64 | Example | Sieve | Wet | Air flow | 150 | Fe | 81.1 | 18.9 | 27.3 | 13.9 | 1.25 |
| 65 | Comparative Example | Sieve | — | — | 200 | Fe | 79.1 | 20.9 | 26.3 | 11.6 | 1.00 |
| 66 | Example | Sieve | Wet | Air flow | 200 | Fe | 81.1 | 18.9 | 26.4 | 14.6 | 1.26 |

In each Example, in which two or more types of classification methods were carried out at the same cut size during manufacture of the large particle powder, A1 was 20.0 or less despite the coating thickness being changed. As described above, A2 was also 20.0 or less. Consequently, DC superimposition characteristics were good.

### Experiment 5

Experiment 5 was conducted as in Sample Nos. 1 and 17 except that the coating provided on the surfaces of the soft magnetic metal particles was changed to a Bi—Zn—B—Si—O based oxide glass coating or a Ba—Zn—B—Si—Al—O based oxide glass coating. The Isat ratio of each Example was calculated using, as a benchmark, Isat of the corresponding Comparative Example carried out under substantially the same conditions except that sieve classification was carried out once. Table 6 shows the results.

Although Table 6 does not show A1, it was confirmed that y₅₀, y₉₀, and y₉₅ of all Examples were about the same as those of Sample No. 17 and that A1 was 20.0 or less in all Examples. It was confirmed that y₅₀, y₉₀, and y₉₅ of all Comparative Examples were about the same as those of Sample No. 1 and that A1 exceeded 20.0 in all Comparative Examples.

TABLE 6

| | | Soft magnetic metal powder | | | | Magnetic core | | | | | |
|---|---|---|---|---|---|---|---|---|---|---|---|
| | | Classification | | | | Small | Area ratio | | | | |
| Sample | Example/ | method | | | | particle | Large | Small | | Isat | Isat |
| No. | Comparative Example | 1st | 2nd | 3rd | Coating type | type | particles | particles | μ0 | (A) | ratio |
| 1 | Comparative Example | Sieve | — | — | P—Zn—Al—O based | Fe | 79.3 | 20.7 | 30.0 | 9.8 | 1.00 |
| 17 | Example | Sieve | Wet | Air flow | P—Zn—Al—O based | Fe | 80.5 | 19.5 | 30.2 | 12.4 | 1.27 |
| 67 | Comparative Example | Sieve | — | — | Bi—Zn—B—Si—O based | Fe | 80.8 | 19.2 | 30.1 | 9.7 | 1.00 |
| 68 | Example | Sieve | Wet | Air flow | Bi—Zn—B—Si—O based | Fe | 78.6 | 21.4 | 30.2 | 12.4 | 1.28 |
| 69 | Comparative Example | Sieve | — | — | Ba—Zn—B—Si—Al—O based | Fe | 79.4 | 20.6 | 30.1 | 9.6 | 1.00 |
| 70 | Example | Sieve | Wet | Air flow | Ba—Zn—B—Si—Al—O based | Fe | 79.4 | 20.6 | 30.1 | 12.4 | 1.29 |

In each Example, in which two or more types of classification methods were carried out at the same cut size during manufacture of the large particle powder, A1 was 20.0 or less despite the coating type being changed. As described above, A2 was also 20.0 or less. Consequently, DC superimposition characteristics were good.

### Experiment 6

Experiment 6 was conducted as in Sample Nos. 1 and 17 except that the various raw materials were weighed so that the soft magnetic metal composition was, in atomic mass ratio, 72.3Fe-18.2Si-9.5B (Sample Nos. 71 and 72), 81.6Fe-3.4Si-13.4B-1.6C (Sample Nos. 73 and 74), 72.7Fe-11.6Si-10.8B-2.7C-2.2Cr (Sample Nos. 75 and 76), 56.0Fe-24.0Co-15.0P-5.0C (Sample Nos. 77 and 78), 56.0Fe-24.0Co-20.0B (Sample Nos. 79 and 80), or 56.0Fe-24.0Co-15.0B-5.0Si (Sample Nos. 81 and 82). The Isat ratio of each Example was calculated using, as a benchmark, Isat of the corresponding Comparative Example carried out under substantially the same conditions except that sieve classification was carried out once. Table 7 shows the results. In Experiment 6, it was confirmed that all the soft magnetic metal powders had an amorphous structure.

Although μ0 is omitted in Table 7, it was confirmed that μ0 of all the samples was around 30.

TABLE 7

| | | Soft magnetic metal powder | | | | | | | | | | | |
|---|---|---|---|---|---|---|---|---|---|---|---|---|---|
| | | | | | | Particle size | | | | | | | |
| | | | | | | distribution of | | | | Magnetic core | | | |
| | | | | | | particles having a | | | | | Area ratio | | |
| Sam- | | | | | | particle size of | | | | Small | Large | Small | |
| ple | Example/ | Classification method | | | | 5.0 μm or more | | | | particle | parti- | parti- | Isat |
| No. | Comparative Example | 1st | 2nd | 3rd | Composition | y₅₀ | y₉₀ | y₉₅ | A1 | type | cles | cles | ratio |
| 1 | Comparative Example | Sieve | — | — | Fe—Co—B—P—Si—Cr based | 7.5 | 20.1 | 29.0 | 23.7 | Fe | 79.3 | 20.7 | 1.00 |
| 17 | Example | Sieve | Wet | Air flow | Fe—Co—B—P—Si—Cr based | 7.4 | 20.0 | 22.8 | 7.6 | Fe | 80.5 | 19.5 | 1.27 |
| 71 | Comparative Example | Sieve | — | — | Fe—Si—B based | 7.3 | 20.0 | 28.9 | 24.4 | Fe | 80.9 | 19.1 | 1.00 |
| 72 | Example | Sieve | Wet | Air flow | Fe—Si—B based | 7.3 | 20.0 | 22.8 | 7.7 | Fe | 80.6 | 19.4 | 1.26 |
| 73 | Comparative Example | Sieve | — | — | Fe—Si—B—C based | 7.4 | 20.0 | 29.0 | 24.3 | Fe | 80.7 | 19.3 | 1.00 |
| 74 | Example | Sieve | Wet | Air flow | Fe—Si—B—C based | 7.4 | 20.1 | 22.7 | 7.0 | Fe | 81.3 | 18.7 | 1.24 |
| 75 | Comparative Example | Sieve | — | — | Fe—Si—B—C—Cr based | 7.3 | 19.9 | 29.0 | 24.9 | Fe | 79.7 | 20.3 | 1.00 |
| 76 | Example | Sieve | Wet | Air flow | Fe—Si—B—C—Cr based | 7.4 | 20.0 | 22.7 | 7.3 | Fe | 78.7 | 21.3 | 1.25 |
| 77 | Comparative Example | Sieve | — | — | Fe—Co—P—C based | 7.4 | 19.9 | 29.0 | 24.6 | Fe | 79.3 | 20.7 | 1.00 |
| 78 | Example | Sieve | Wet | Air flow | Fe—Co—P—C based | 7.3 | 19.9 | 22.7 | 7.7 | Fe | 79.1 | 20.9 | 1.21 |
| 79 | Comparative Example | Sieve | — | — | Fe—Co—B based | 7.4 | 20.0 | 28.9 | 24.1 | Fe | 79.5 | 20.5 | 1.00 |
| 80 | Example | Sieve | Wet | Air flow | Fe—Co—B based | 7.4 | 20.0 | 22.8 | 7.6 | Fe | 80.0 | 20.0 | 1.23 |
| 81 | Comparative Example | Sieve | — | — | Fe—Co—B—Si based | 7.4 | 20.1 | 28.9 | 23.8 | Fe | 78.7 | 21.3 | 1.00 |
| 82 | Example | Sieve | Wet | Air flow | Fe—Co—B—Si based | 7.5 | 20.1 | 22.7 | 6.9 | Fe | 80.0 | 20.0 | 1.24 |

In each Example, in which two or more types of classification methods were carried out at the same cut size during manufacture of the large particle powder, A1 was 20.0 or less despite the composition of the large particles being changed. As described above, A2 was also 20.0 or less. Consequently, DC superimposition characteristics were good.

### Experiment 7

Experiment 7 was conducted as in Sample Nos. 1 and 17 except that the various raw materials were weighed so that the soft magnetic metal composition was, in atomic mass ratio, 73.5Fe-13.5Si-9.0B-3.0Nb-1.0Cu (Sample Nos. 83 and 84), 79.0Fe-1.0Si-10.0B-7.0Nb-3.0P (Sample Nos. 85 and 86), 63.2Fe-15.8Co-11.0B-9.0P-1.0Si (Sample Nos. 87 and 88), or 63.2Fe-15.8Co-10.0B-5.0P-5.0Si-1.0Cr (Sample Nos. 89 and 90); and that the soft magnetic metal powder was subject to a heat treatment for depositing nanocrystals having a crystal grain size of 30 nm or less to reduce the amorphous ratio X to 10%. The heat treatment was carried out specifically at 400° C. to 650° C. for 10 to 60 minutes. The Isat ratio of each Example was calculated using, as a benchmark, Isat of the corresponding Comparative Example carried out under substantially the same conditions except that sieve classification was carried out once. Table 8 shows the results. In Experiment 7, it was confirmed that all the soft magnetic metal powders had a nanocrystalline structure.

Although μ0 is omitted in Table 8, it was confirmed that μ0 of all the samples was around 30.

TABLE 8

| | | Soft magnetic metal powder | | | | | | | | | | | |
|---|---|---|---|---|---|---|---|---|---|---|---|---|---|
| | | | | | | Particle size | | | | | | | |
| | | | | | | distribution of | | | | Magnetic core | | | |
| | | | | | | particles having a | | | | | Area ratio | | |
| Sam- | | | | | | particle size of | | | | Small | Large | Small | |
| ple | Example/ | Classification method | | | | 5.0 μm or more | | | | particle | parti- | parti- | Isat |
| No. | Comparative Example | 1st | 2nd | 3rd | Composition | y₅₀ | y₉₀ | y₉₅ | A1 | type | cles | cles | ratio |
| 83 | Comparative Example | Sieve | — | — | Fe—Si—B—Nb—Cu based | 7.5 | 19.9 | 28.9 | 24.0 | Fe | 80.4 | 19.6 | 1.00 |
| 84 | Example | Sieve | Wet | Air flow | Fe—Si—B—Nb—Cu based | 7.4 | 20.0 | 22.6 | 7.0 | Fe | 79.6 | 20.4 | 1.26 |
| 85 | Comparative Example | Sieve | — | — | Fe—Si—B—Nb—P based | 7.4 | 19.9 | 29.0 | 24.6 | Fe | 80.5 | 19.5 | 1.00 |
| 86 | Example | Sieve | Wet | Air flow | Fe—Si—B—Nb—P based | 7.4 | 20.0 | 22.7 | 7.3 | Fe | 78.6 | 21.4 | 1.25 |
| 87 | Comparative Example | Sieve | — | — | Fe—Co—B—P—Si based | 7.3 | 20.1 | 28.8 | 23.8 | Fe | 78.9 | 21.1 | 1.00 |
| 88 | Example | Sieve | Wet | Air flow | Fe—Co—B—P—Si based | 7.4 | 20.1 | 22.8 | 7.3 | Fe | 78.6 | 21.4 | 1.21 |
| 89 | Comparative Example | Sieve | — | — | Fe—Co—B—P—Si—Cr based | 7.4 | 20.0 | 28.9 | 24.1 | Fe | 79.6 | 20.4 | 1.00 |
| 90 | Example | Sieve | Wet | Air flow | Fe—Co—B—P—Si—Cr based | 7.5 | 20.1 | 22.6 | 6.7 | Fe | 80.7 | 19.3 | 1.23 |

In each Example, in which two or more types of classification methods were carried out at the same cut size during manufacture of the large particle powder, A1 was 20.0 or less despite the composition of the large particles and the microstructure being changed. As described above, A2 was also 20.0 or less. Consequently, DC superimposition characteristics were good.

### Experiment 8

Experiment 8 was conducted as in Sample Nos. 1 and 17 except that the various raw materials were weighed so that the soft magnetic metal composition was, in atomic mass ratio, 88.0Fe-12.0Si (Sample Nos. 91 and 92), 55.0Fe-45.0Ni (Sample Nos. 95 and 96), 89.4Fe-8.6Si-2.0Cr (Sample Nos. 97 and 98), 73.7Fe-16.4Si-9.9Al (Sample Nos. 99 and 100), 78.1Fe-11.0Si-10.0Al-0.9Ni (Sample Nos. 101 and 102), 49.2Fe-42.0Ni-4.0Si-4.8Co (Sample Nos. 103 and 104), 50.0Fe-50.0Co (Sample Nos. 105 and 106), 49.0Fe-49.0Co-2.0V (Sample Nos. 107 and 108), 83.6Fe-4.4Co-12.0Si (Sample Nos. 109 and 110), or 66.3Fe-7.4Co-16.4Si-9.9Al (Sample Nos. 111 and 112). The soft magnetic metal powders of Sample Nos. 93 and 94 had a composition substantially containing only Fe. In Sample Nos. 93 and 94, it was not possible to distinguish between the large particles and the small particles using SME or EDS. However, the corresponding soft magnetic metal powder (large particle powder) and the small particle powder were mixed so that, on the supposition that the large particles and the small particles were distinguishable, the area ratio of the large particles to the small particles was about 80:20. The Isat ratio of each Example was calculated using, as a benchmark, Isat of the corresponding Comparative Example carried out under substantially the same conditions except that sieve classification was carried out once. Table 9 shows the results. In Experiment 8, it was confirmed that all the soft magnetic metal powders had a crystalline structure.

Although μ0 is omitted in Table 9, it was confirmed that μ0 of all the samples was around 30.

TABLE 9

| | | Soft magnetic metal powder | | | | | | | | | | | |
|---|---|---|---|---|---|---|---|---|---|---|---|---|---|
| | | | | | | Particle size | | | | | | | |
| | | | | | | distribution of | | | | | | | |
| | | | | | | particles having a | | | | Magnetic core | | | |
| Sam- | | | | | | particle size of | | | | Small | Area ratio | | |
| ple | Example/ | Classification method | | | | 5.0 μm or more | | | | particle | Large | Small | Isat |
| No. | Comparative Example | 1st | 2nd | 3rd | Composition | y₅₀ | y₉₀ | Y₉₅ | A1 | type | particles | particles | ratio |
| 91 | Comparative Example | Sieve | — | — | Fe—Si based | 7.4 | 19.9 | 28.8 | 24.1 | Fe | 80.5 | 19.5 | 1.00 |
| 92 | Example | Sieve | Wet | Air flow | Fe—Si based | 7.5 | 20.0 | 22.6 | 6.9 | Fe | 80.6 | 19.4 | 1.18 |
| 93 | Comparative Example | Sieve | — | — | Fe based | 7.4 | 19.9 | 29.0 | 24.6 | Fe | About 80 | About 20 | 1.00 |
| 94 | Example | Sieve | Wet | Air flow | Fe based | 7.4 | 20.0 | 22.8 | 7.6 | Fe | About 80 | About 20 | 1.17 |
| 95 | Comparative Example | Sieve | — | — | Fe—Ni based | 7.3 | 20.0 | 28.9 | 24.4 | Fe | 80.3 | 19.7 | 1.00 |
| 96 | Example | Sieve | Wet | Air flow | Fe—Ni based | 7.4 | 19.9 | 22.8 | 7.8 | Fe | 78.9 | 21.1 | 1.16 |
| 97 | Comparative Example | Sieve | — | — | Fe—Si—Cr based | 7.4 | 20.0 | 28.9 | 24.1 | Fe | 80.4 | 19.6 | 1.00 |
| 98 | Example | Sieve | Wet | Air flow | Fe—Si—Cr based | 7.3 | 20.1 | 22.7 | 7.1 | Fe | 80.1 | 19.9 | 1.18 |
| 99 | Comparative Example | Sieve | — | — | Fe—Si—Al based | 7.4 | 19.9 | 28.9 | 24.3 | Fe | 81.1 | 18.9 | 1.00 |
| 100 | Example | Sieve | Wet | Air flow | Fe—Si—Al based | 7.4 | 19.9 | 22.6 | 7.3 | Fe | 80.8 | 19.2 | 1.18 |
| 101 | Comparative Example | Sieve | — | — | Fe—Si—Al—Ni based | 7.4 | 20.1 | 29.0 | 24.1 | Fe | 81.1 | 18.9 | 1.00 |
| 102 | Example | Sieve | Wet | Air flow | Fe—Si—Al—Ni based | 7.3 | 20.1 | 22.7 | 7.1 | Fe | 79.2 | 20.8 | 1.16 |
| 103 | Comparative Example | Sieve | — | — | Fe—Ni—Si—Co based | 7.4 | 20.0 | 28.9 | 24.1 | Fe | 79.3 | 20.7 | 1.00 |
| 104 | Example | Sieve | Wet | Air flow | Fe—Ni—Si—Co based | 7.4 | 20.0 | 22.6 | 7.0 | Fe | 79.9 | 20.1 | 1.18 |
| 105 | Comparative Example | Sieve | — | — | Fe—Co based | 7.4 | 20.0 | 29.0 | 24.3 | Fe | 80.6 | 19.4 | 1.00 |
| 106 | Example | Sieve | Wet | Air flow | Fe—Co based | 7.4 | 20.0 | 22.6 | 7.0 | Fe | 80.4 | 19.6 | 1.19 |
| 107 | Comparative Example | Sieve | — | — | Fe—Co—V based | 7.4 | 20.0 | 28.9 | 24.1 | Fe | 80.2 | 19.8 | 1.00 |
| 108 | Example | Sieve | Wet | Air flow | Fe—Co—V based | 7.4 | 20.0 | 22.6 | 7.0 | Fe | 80.5 | 19.5 | 1.17 |
| 109 | Comparative Example | Sieve | — | — | Fe—Co—Si based | 7.4 | 20.1 | 29.0 | 24.1 | Fe | 79.3 | 20.7 | 1.00 |
| 110 | Example | Sieve | Wet | Air flow | Fe—Co—Si based | 7.3 | 20.1 | 22.6 | 6.8 | Fe | 79.4 | 20.6 | 1.16 |
| 111 | Comparative Example | Sieve | — | — | Fe—Co—Si—Al based | 7.4 | 20.0 | 28.8 | 23.8 | Fe | 79.9 | 20.1 | 1.00 |
| 112 | Example | Sieve | Wet | Air flow | Fe—Co—Si—Al based | 7.4 | 20.0 | 22.7 | 7.3 | Fe | 80.0 | 20.0 | 1.18 |

In each Example, in which two or more types of classification methods were carried out at the same cut size during manufacture of the large particle powder, A1 was 20.0 or less despite the composition of the large particles and the microstructure being changed. As described above, A2 was also 20.0 or less. Consequently, DC superimposition characteristics were good.

### Experiment 9

Experiment 9 was conducted as in Sample No. 17 except that the small particle powder was partly replaced by a medium particle powder including medium particles described later. In Sample No. 113, a medium particle powder including Fe—Si—B—Nb—Cu based alloy particles having an average particle size of 5 μm and having a nanocrystalline structure was used. In Sample No. 114, a medium particle powder including Fe—Si—B based alloy particles having an average particle size of 5 μm and having an amorphous structure was used. In Sample No. 115, a medium particle powder including Fe—Si based alloy particles having an average particle size of 5 μm and having a crystalline structure was used. Table 10 shows the results.

Because the large particle powder was the same as that of Sample No. 17, y₅₀, y₉₀, and y₉₅ were the same as those of Sample No. 17, and A1 was 20.0 or less in all Examples.

TABLE 10

| | | Magnetic core | | | | | |
|---|---|---|---|---|---|---|---|
| | Example/ | | Area ratio (%) | | | | |
| Sample | Comparative | Medium | Large | Medium | Small | | Isat |
| No. | Example | particles | particles | particles | particles | μ0 | (A) |
| 17 | Example | N/A | 80.5 | 0.0 | 19.5 | 30.2 | 12.4 |
| 113 | Example | Nanocrystalline | 80.2 | 10.1 | 9.7 | 30.2 | 12.3 |
| 114 | Example | Amorphous | 80.2 | 10.2 | 9.6 | 30.2 | 12.3 |
| 115 | Example | Crystalline | 80.1 | 10.2 | 9.7 | 30.1 | 12.6 |

According to Table 10, there was no great change in Isat despite the small particle powder partly being replaced by the medium particle powder.

Further, the small particle powder of Sample No. 1 was partly replaced by a medium particle powder including medium particles described later. Despite that, there was no great change in Isat provided that a resulting magnetic core had a permeability equivalent to that of the magnetic core of Sample No. 1. As shown in Table 10, permeability and Isat of Sample Nos. 113 to 115 were about the same as those of Sample No. 17. Thus, the respective Isat ratios of Sample Nos. 113 to 115 were about the same as the Isat ratio of Sample No. 17.

In Sample Nos. 113 to 115, the small particle powder of Sample No. 17 was partly replaced by the corresponding medium particle powder to change the particle size distribution of the soft magnetic metal particles with a Heywood diameter of 5.0 μm or more in the magnetic core. Thus, Y₅₀, Y₉₀, and Y₉₅ were changed, and A2 was changed. It was confirmed that A2 of Sample Nos. 113 to 115 were 20.0 or less similarly to A2 of Sample No. 17.

### Experiment 10

In Sample No. 116, an Fe—Ni powder was used as the small particle powder. In Sample No. 117, an Fe—Si powder was used as the small particle powder. In Sample No. 118, an Fe—Co powder was used as the small particle powder. Other conditions of these samples were the same as those of Sample No. 17. Table 11 shows the results.

Because the large particle powder was the same as that of Sample No. 17, y₅₀, y₉₀, and y₉₅ were the same as those of Sample No. 17, and A1 was 20.0 or less in all Examples.

TABLE 11

| | | Magnetic core | | | | |
|---|---|---|---|---|---|---|
| | Example/ | Small | Area ratio | | | |
| Sample | Comparative | particle | Large | Small | | Isat |
| No. | Example | type | particles | particles | μ0 | (A) |
| 17 | Example | Fe | 80.5 | 19.5 | 30.2 | 12.4 |
| 116 | Example | Fe—Ni | 79.3 | 20.7 | 30.2 | 12.3 |
| 117 | Example | Fe—Si | 78.8 | 21.2 | 30.2 | 12.5 |
| 118 | Example | Fe—Co | 78.6 | 21.4 | 30.1 | 12.6 |

According to Table 11, there was no great change in Isat despite the composition of the small particle powder being changed. As described above, A2 was also 20.0 or less.

Further, the composition of the small particle powder of Sample No. 1 was changed. Despite that, there was no great change in Isat provided that a resulting magnetic core had a permeability equivalent to that of the magnetic core of Sample No. 1. As shown in Table 11, permeability and Isat of Sample Nos. 116 to 118 were about the same as those of Sample No. 17. Thus, the respective Isat ratios of Sample Nos. 116 to 118 were about the same as the Isat ratio of Sample No. 17.

### Experiment 11

Experiment 11 was conducted as in Sample Nos. 1 and 17 except that the amount of the epoxy resin was changed to change the area ratio of the magnetic materials in the magnetic core. Table 12 shows the results.

In all the samples of Experiments 1 to 10, the amount of the resin was the same, and the area ratio of the magnetic materials was about 85%.

TABLE 12

| | | Soft magnetic metal powder | | | | | | | | | | | | | | |
|---|---|---|---|---|---|---|---|---|---|---|---|---|---|---|---|---|
| | | | | | Particle size | | | | Magnetic core | | | | | | | |
| | | | | | distribution of | | | | | Resin | Area | | | | | |
| | | | | | particles having a | | | | | amount | ratio of | Area ratio | | | | |
| Sam- | | | | | particle size of | | | | Small | (parts | magnetic | Large | Small | | | |
| ple | Example/ | Classification method | | | 5.0 μm or more | | | | particle | by | materials | parti- | parti- | | Isat | Isat |
| No. | Comparative Example | 1st | 2nd | 3rd | y₅₀ | y₉₀ | y₉₅ | A1 | type | mass) | (%) | cles | cles | μ0 | (A) | ratio |
| 119 | Comparative Example | Sieve | — | — | 7.5 | 20.1 | 29.0 | 23.7 | Fe | 1.0 | 94.1 | 80.5 | 19.5 | 37.0 | 8.9 | 1.00 |
| 120 | Example | Sieve | Wet | Air flow | 7.5 | 20.0 | 22.8 | 7.5 | Fe | 1.0 | 94.3 | 79.0 | 21.0 | 37.2 | 10.5 | 1.18 |
| 121 | Comparative Example | Sieve | — | — | 7.5 | 20.1 | 29.0 | 23.7 | Fe | 1.5 | 89.9 | 80.1 | 19.9 | 36.1 | 9.2 | 1.00 |
| 122 | Example | Sieve | Wet | Air flow | 7.5 | 20.0 | 22.8 | 7.5 | Fe | 1.5 | 89.8 | 81.3 | 18.7 | 36.3 | 11.6 | 1.26 |
| 123 | Comparative Example | Sieve | — | — | 7.5 | 20.1 | 29.0 | 23.7 | Fe | 2.0 | 88.2 | 79.6 | 20.4 | 32.2 | 9.6 | 1.00 |
| 124 | Example | Sieve | Wet | Air flow | 7.5 | 20.0 | 22.8 | 7.5 | Fe | 2.0 | 88.3 | 80.2 | 19.8 | 32.2 | 12.1 | 1.26 |
| 1 | Comparative Example | Sieve | — | — | 7.5 | 20.1 | 29.0 | 23.7 | Fe | 2.5 | 85.3 | 79.3 | 20.7 | 30.0 | 9.8 | 1.00 |
| 17 | Example | Sieve | Wet | Air flow | 7.5 | 20.0 | 22.8 | 7.5 | Fe | 2.5 | 85.4 | 80.5 | 19.5 | 30.2 | 12.4 | 1.27 |
| 125 | Comparative Example | Sieve | — | — | 7.5 | 20.1 | 29.0 | 23.7 | Fe | 3.0 | 82.1 | 79.6 | 20.4 | 28.1 | 10.9 | 1.00 |
| 126 | Example | Sieve | Wet | Air flow | 7.5 | 20.0 | 22.8 | 7.5 | Fe | 3.0 | 82.1 | 79.1 | 20.9 | 28.2 | 13.2 | 1.21 |
| 127 | Comparative Example | Sieve | — | — | 7.5 | 20.1 | 29.0 | 23.7 | Fe | 5.0 | 70.3 | 80.0 | 20.0 | 24.1 | 12.1 | 1.00 |
| 128 | Example | Sieve | Wet | Air flow | 7.5 | 20.0 | 22.8 | 7.5 | Fe | 5.0 | 70.1 | 79.6 | 20.4 | 24.2 | 14.2 | 1.17 |

According to Table 12, in each Example, in which two or more types of classification methods were carried out at the same cut size during manufacture of the large particle powder, A1 was 20.0 or less despite the amount of the resin being changed. As described above, A2 was also 20.0 or less. Consequently, DC superimposition characteristics were good.

What is claimed is:

1. A soft magnetic metal powder comprising:
soft magnetic metal particles with a particle size of 5.0 μm or more,
wherein (y₉₅/y₅₀−y₉₀/y₅₀)/(0.95−0.90) is 20.0 or less, where y₉₅ (μm) denotes D95, y₉₀ (μm) denotes D90, and y₅₀ (μm) denotes D50 of a particle size distribution of the soft magnetic metal particles with a particle size of 5.0 μm or more.

2. The soft magnetic metal powder according to claim 1, wherein D50 of a particle size distribution of all soft magnetic metal particles included in the soft magnetic metal powder is 3.0 μm or more and 30.0 μm or less.

3. A magnetic core comprising the soft magnetic metal powder according to claim 1.

4. A magnetic component comprising the soft magnetic metal powder according to claim 1.

5. A magnetic core comprising:
soft magnetic metal particles with a Heywood diameter of 5.0 μm or more in a section of the magnetic core,
wherein (Y₉₅/Y₅₀−Y₉₀/Y₅₀)/(0.95−0.90) is 20.0 or less, where Y₉₅ (μm) denotes D95, Y₉₀ (μm) denotes D90, and Y₅₀ (μm) denotes D50 of a particle size distribution of the soft magnetic metal particles with a Heywood diameter of 5.0 μm or more.

6. The magnetic core according to claim 5, wherein a magnetic material accounts for an area ratio of 70% or more and 95% or less of a section of the magnetic core.

7. A magnetic component comprising the magnetic core according to claim 5.
